(19) United States
(12) Patent Application Publication
(10) Pub. No.: US 2006/0227223 A1
(43) Pub. Date: Oct. 12, 2006

(54) Image reproducing apparatus

(76) Inventor: Hiroshi Nagata, Tokyo (JP)

Correspondence Address: STRAUB & POKOTYLO, 620 TINTON AVENUE, BLDG. B, 2ND FLOOR, TINTON FALLS, NJ, 07724, US

(21) Appl. No.: 11/361,687

(22) Filed: Feb. 24, 2006

(30) Foreign Application Priority Data
Mar. 1, 2005 (JP) 2005-056714

(51) Int. Cl. H04N 5/76

(52) U.S. Cl. 348/231.5

(57) ABSTRACT

The present invention makes it easy to switch from calendar display to album viewing in an image reproducing apparatus having a calendar display function and an album viewing function. For example, when a calendar control file is used for the calendar display function and an album control file is used for the album viewing function, information for the link to album control file is recorded in the calendar control file.

### CROSS-REFERENCE TO RELATED APPLICATION

This application is based upon and claims the benefit of priority from prior Japanese Patent Application No. 2005-056714, filed on Mar. 1, 2005, the entire contents of which are incorporated herein by reference.

### BACKGROUND OF THE INVENTION

1. Field of the Invention

The present invention relates to an image reproducing apparatus provided with a calendar display function and an album viewing function. The calendar display function is a function for displaying a calendar on an image reproducing apparatus, with images shot within a predetermined period displayed on the calendar in units of a predetermined area, each corresponding to the predetermined period, such as a day or a month on the calendar. The album viewing function is a function for displaying only favorite images registered by a user in an album stored in the image reproducing apparatus.

2. Description of the Related Art

Conventionally, there is known an image reproducing apparatus provided with a calendar display function. For example, Japanese Patent Laid-Open No. H11-215457 discloses a digital camera as an image reproducing apparatus, which displays a calendar together with images shot on each day or in each month on the calendar. Further, Japanese Patent Laid-Open No. 2004-260710 discloses a digital still camera as an image reproducing apparatus, which displays a calendar together with a representative image selected from images shot on each day or in each month on the calendar.

Among image reproducing apparatuses provided with such a calendar display function, there are some apparatuses also having an album viewing function.

However, the image reproducing apparatuses having both the calendar display function and the album viewing function is insufficient in terms of cooperation between the calendar display function and the album viewing function. For example, suppose that a user uses the calendar display function of the image reproducing apparatus to display a calendar for a month with representative images shown on a daily basis. Suppose further that the user uses the album viewing function to view an album in which one of the representative images displayed on the calendar for the month is registered.

In this case, the user has once to close the calendar display, and to perform a sequence of operations to display an album selection screen and select a desired album from all albums listed on the album selection screen. Further, in this case, the user has to select an album on the album selection screen by retracing his or her memory to remember in which album the desired representative image displayed on the calendar is registered.

### BRIEF SUMMARY OF THE INVENTION

An image reproducing apparatus according to the present invention includes a system controller and a data bus connected to the system controller and accessible to a recording medium. The system controller has at least a calendar display function and an album viewing function, and is configured to enable switching from calendar display to album viewing.

For the calendar display function, a calendar control file can be used, for example. The calendar control file is a file recorded on the recording medium in units of a first predetermined period and containing at least a list of representative image files in units of a second predetermined period shorter than the first predetermined period. For example, it can be selected such that the first predetermined period is a month and the second predetermined period is a day. Alternatively, it can also be such that the first predetermined period is a year and the second predetermined period is a month. The representative image means an image selected from all images shot during the second predetermined period. For example, an image with the earliest shooting date or the latest shooting date can be selected as the representative image from all images shot during the second predetermined period. The calendar display function can display the representative image in each area corresponding to each second predetermined period on the calendar based on the calendar control file.

For the album viewing function, an album control file can be used, for example. The album control file is a file recorded on the recording medium and containing at least a list of image files for album viewing.

The image reproducing apparatus according to the present invention can switch from the calendar display to the album viewing based on a list of album control files described in the calendar control file and the album control file.

The system controller can further has an album control file creating function for creating an album control file describing a list of image files for album viewing, and a recording function for recording, on the recording medium, the album control file created by the album control file creating function. When the album control file is recorded on the recording medium by the recording function, the system controller can also determine whether a calendar control file in which the same file name as that of an image file listed in the album control file is described in the list of representative image files is recorded on the recording medium. In this case, the system controller can also include a first calendar control file updating function for adding the album control file to the calendar control file on condition that the calendar control file concerned is recorded on the recording medium.

The system controller can further include an album control file updating function for adding an image file for album viewing to the list of image files in an album control file recorded on the recording medium. When the image file for album viewing is added to the album control file by the album control file updating function, the system controller can also determine whether a calendar control file in which the same file name as that of the image file added to the album control file is described in the list of representative image files is recorded on the recording medium. In this case, the system controller can also include a second calendar control file updating function for adding the album control file to the list of album control files in the calendar control file on condition that the calendar control file concerned is recorded on the recording medium.

In the image reproducing apparatus, the calendar display function can perform calendar display for each first predetermined period in such a manner as to display a representative image in each area corresponding to each second predetermined period on the calendar based on the calendar control file recorded on the recording medium. In this case, when the calendar display is switched to album viewing, an album control file selected based on the list of album control files in the calendar control file corresponding to the first predetermined period can be read to perform album viewing based on the album control file.

In the image reproducing apparatus, the calendar display function can further perform calendar display for a third predetermined period, longer than the first predetermined period, in such a manner as to display a representative image in each area corresponding to each first predetermined period on the calendar based on the calendar control file recorded on the recording medium. In this case, when the calendar display is switched to album viewing, an album control file selected based on the list of album control files in the calendar control file corresponding to the first predetermined period the representative image of which is displayed on the calendar can be read to perform album viewing based on the album control file.

The present invention can also be considered to provide a file system for recoding image data. In this case, the file system includes at least a plurality of image data, a first file having link information to image data selected from the plurality of image data as having been shot during a predetermined period, and a second file having link information to image data selected from the plurality of image data as being categorized under a specific theme. The first file has album link information as link information to the second file having the link information to the image data to which the first file has link information.

The present invention can further be considered to provide an image reproducing apparatus having a calendar display function for displaying, on a calendar divided into a plurality of predetermined periods, image data shot at least during part of the predetermined periods, and an album viewing function for displaying images categorized under a specific theme. The image reproducing apparatus also has, as its features, a function for specifying a desired image from the images displayed by the calendar display function, and a function for switching the display of the specified image from the display made by the calendar display function to the display made by the album viewing function.

The present invention can make it easy to switch from calendar display for displaying a representative image in each area corresponding to each predetermined period on a calendar to album viewing for enabling the viewing of an album in which the representative image is registered.

### BRIEF DESCRIPTION OF THE SEVERAL VIEWS OF THE DRAWINGS

These and other features, aspects, and advantages of the apparatus and methods of the present invention will become better understood with regard to the following description, appended claims, and accompanying drawings where:

FIG. 1 is a block diagram showing the principle configuration of a digital camera provided with an image reproducing apparatus according to one preferred embodiment of the present invention;

FIG. 2 is a diagram showing an example of the file structure of a removable memory card with control files recorded on it;

FIG. 3 is a diagram showing the descriptive contents of album control files;

FIG. 4 is a diagram showing the descriptive contents of calendar control files;

FIG. 5 is a diagram for explaining the outline of calendar display operation;

FIG. 6 is a diagram for explaining the outline of album registration operation;

FIG. 7 is a diagram for explaining the outline of switching operation from calendar display to album viewing;

FIG. 8 is a flowchart showing the operation related to the registration of a calendar control file performed when a user shoots a photo and records an image file;

FIG. 9 is a flowchart showing the operation related to the registration of a calendar control file performed when an image file from an external apparatus is recorded;

FIG. 10 is a flowchart relating to the calendar display operation when the mode is changed to a monthly calendar display mode;

FIG. 11 is a flowchart relating to the calendar display operation when a cursor frame is moved at a press of a Down key;

FIG. 12 is a flowchart relating to the calendar display operation when the mode is changed to an annual calendar display mode;

FIG. 13 is a flowchart showing the album registration operation;

FIG. 14 is a flowchart showing the switching operation from annual calendar display to album viewing; and

FIG. 15 is a flowchart showing the switching operation from monthly calendar display to album viewing.

### DETAILED DESCRIPTION OF THE PREFERRED EMBODIMENTS

A preferred embodiment of the invention is described below with reference to the accompanying drawings.

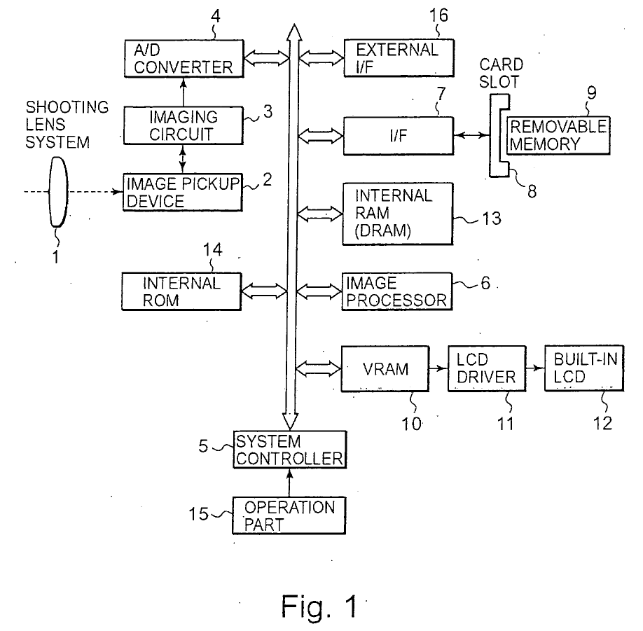

FIG. 1 is a block diagram showing the principle configuration of a digital camera provided with an image reproducing apparatus according to one preferred embodiment of the present invention. The digital camera according to the embodiment is designed to conform to the DCF (Design rule for Camera File system) standard.

Upon shooting with the digital camera in FIG. 1, a subject image is formed by a shooting lens system 1, photoelectrically converted by an image pickup device 2 into an electrical signal, subjected to a predetermined imaging process through an imaging circuit 3, and A/D converted by an A/D converter 4. The A/D converted digital data (image data) is temporarily stored in an internal RAM (DRAM) 13. The temporarily stored image data is subjected to predetermined image processing by means of a system controller 5, compressed by an image processor 6 in a predetermined manner, and recorded as an image file on a removable memory card 9 inserted in a card slot 8 through an I/F 7.

Upon playback, the image data is read from the removable memory card 9 through the card slot 8 and the I/F 7, expanded or decompressed by the image processor 6 in a predetermined manner, subjected to predetermined image processing by means of the system controller 5, and stored in a VRAM 10. Then, an image of the image data stored in the VRAM is displayed on a built-in LCD 12 via an LCD driver 11.

In FIG. 1, the internal-RAM 13 is used not only for temporary storage of image data A/D converted by the A/D converter 4, but also for other uses. For example, the internal RAM 13 is also used for temporary storage of image data being processed by the image processor 6, and as a work area for the system controller 5 to perform control processing, including the creation and updating of a calendar control file or an album control file to be described later.

The system controller 5 includes a CPU (Central Processing Unit), which reads out and executes a camera program stored in an internal ROM 14 to control the entire operation of the digital camera.

The operation part 15 includes various buttons and switches, such as zoom buttons (Wide button and Tele button), a cross-shaped cursor button with Up, Down, Left, and Right keys), and an OK button, to inform the system controller 5 of the instructions accepted. The zoom buttons are used not only to instruct zooming in (Tele button) or zooming out (Wide button), but also to instruct switching between various display modes. The display modes include a one-frame display mode, a monthly calendar display mode to show a calendar for each month, such as January, February, etc., and a annual calendar display mode to show a calendar for each year, such as 2004, 2005, etc. The cross-shaped cursor button is to instruct switching between frames to be displayed or the movement of a cursor frame. The OK button is to instruct the selection of an item or option, or the display of a selection menu.

An external I/F 16 enables the exchange of data with an external device such as a PC (Personal Computer) through a USB cable or the like. Through this I/F 16, image files recorded in the external device can be moved or copied to the removable memory card 9.

The following describes the operation of the digital camera.

The digital camera has a calendar display function for displaying a monthly or annual calendar on the built-in LCD 12. In the monthly calendar display mode, a single image representative of all images shot on each day is displayed in an area of the day on the monthly calendar based on a calendar control file recorded on the removable memory card 9. In the annual calendar display mode, a single image representative of all images shot in each month is displayed in an area of the month on the annual calendar. The digital camera can make such a calendar display smoothly at high speed.

The digital camera can easily switch from calendar display to album viewing based on the calendar control file and an album control file recorded on the removable memory card 9. In other words, a user can easily search for an album from an image on the monthly or annual calendar displayed on the built-in LCD 12 to view the album in which the image is registered.

The calendar display operation and the switching operation from calendar display to album viewing will be described in detail below.

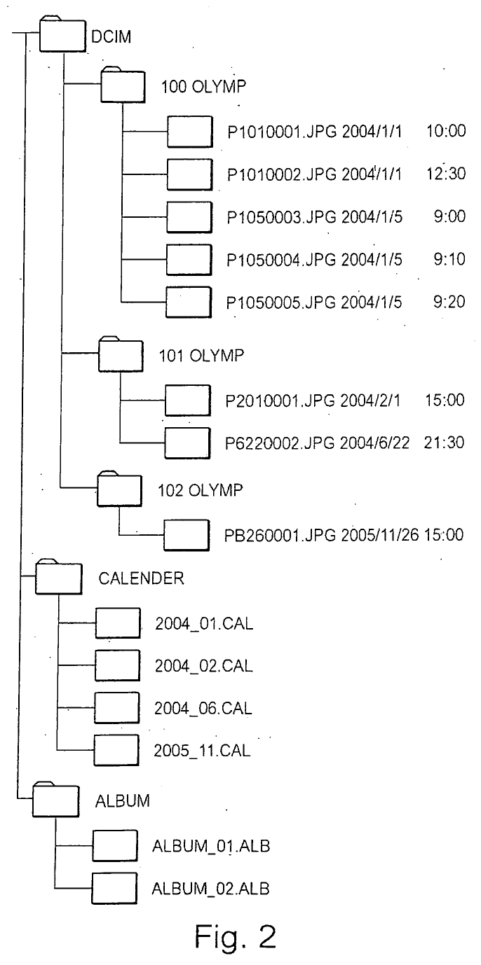

First, the calendar control file and the album control file will be described with reference to FIGS. 2 through 4.

FIG. 2 is a diagram showing an example of the file structure of the removable memory card 9 with the control file recorded on it.

As shown in FIG. 2, a “DCIM” folder, a “CALENDAR” folder, and an “ALBUM” folder are located underneath a root folder on the removable memory card 9. Image files (*.jpg) are stored underneath the “DCIM” folder. Calendar control files (year_month.CAL) are stored underneath the “CALENDAR” folder. Album control files (*.ALB) are stored underneath the “ALBUM” folder.

The image files underneath the “DCIM” folder contain information on each shooting date and time (shooting year, month, date, and time) and the like as well as image data. The shooting date/time information is described in each image file, for example, with Exif (Exchangeable Image File Format) tags. In FIG. 2, the shooting date/time information is shown together with the image file (for example, “P1010001.jpg 2004/1/1 10:00” etc.). Note here that the shooting date/time information is represented in FIG. 2 in the form of “year/month/day and time.”

In the embodiment, the shooting date/time information contained in each image file is used as the above-mentioned shooting date/time information. However, the shooting date/time information can also be obtained from another source. For example, the date/time information (year/month/day information) from the DOS time stamp described in each directory entry on the removable memory card 9 can also be used as the shooting date/time information.

In each of the calendar control files below the “CALENDAR” folder, image file information including the shooting date of the image recorded on the removable memory card 9 is recorded on a monthly basis. When an image file is recorded on the removable memory card 9, a calendar control file is created and recorded only on condition that the calendar control file corresponding to the month including the shooting date and time of the image file is not recorded on the removable memory card 9. In FIG. 2, since the shooting dates and times of all the image files recorded on the removable memory card 9 are included in 2004/01, 2004/02, 2004/06, and 2005/11 (each represented in the form of YYYY/MM), four calendar control files corresponding to 2004/01, 2004/02, 2004/06, and 2005/11 are recorded.

Each of the album control files underneath the “ALBUM” folder is created and recorded each time a user instructs the creation of an album. In FIG. 2, two album control files are recorded.

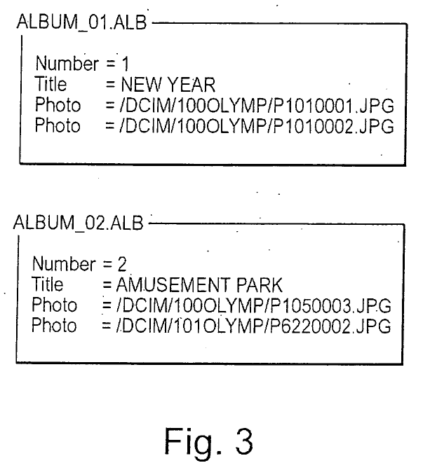

FIG. 3 is a diagram showing the descriptive contents of the album control files.

As shown in FIG. 3, an album number (“Number”), an album title (“Title”), and a list of image files (“Photo”) registered in the album are described in each of the album control files.

For example, described in the album control file “ALBUM_{—}01.ALB,” are “1” as the album number, “New Year” as the album title, and “/DCIM/100OLYMP/P1010001.jpg” and “/DCIM/100OLYMP/P1010002.jpg” as the list of image files registered in the album.

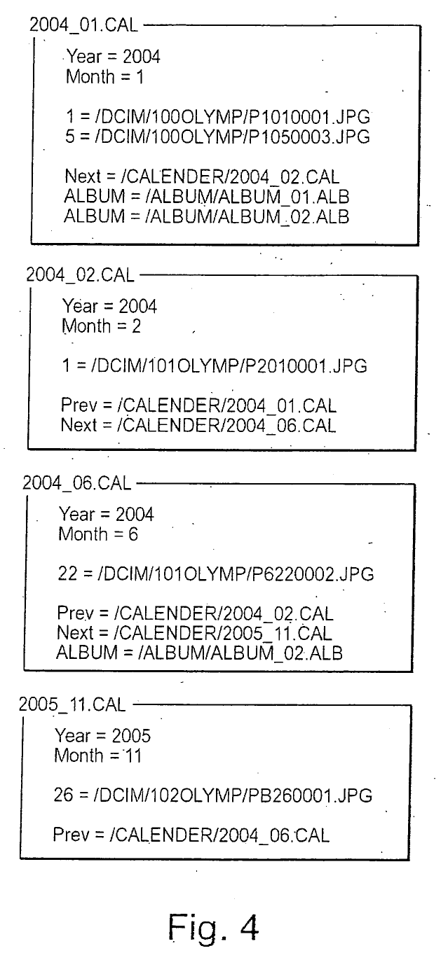

FIG. 4 is a diagram showing the descriptive contents of the calendar control files.

As shown in FIG. 4, “Year” and “Month” specifying to what year and month a calendar control file relates are described in the control file. In the calendar control file, a list of image files with the shooting dates included in the month is described one by one on a daily basis. In this case, if there are two or more image files with the same shooting date, the file name of a single representative image file is described as a list of image-files on that day. In the embodiment, the file name of an image file with the earliest shooting time on that day is described. However, the present invention is not limited thereto. For example, the file name of an image file with the latest time on that day can be described instead. The list of representative image files is a list of image files described one by one on a daily basis.

For example, in the calendar control file “2004_{—}01.CAL” in FIG. 4, “2004” and “1” are described as the year and month of the calendar control file. Then, a list of representative image files with the shooting dates included in January 2004 is described on a daily basis. Specifically, a list of image files “/DCIM/100OLYMP/P1010001.JPG” with the earliest shooting time on Day =“1” (the first day) of the month and “/DCIM/100OLYMP/P1050003.JPG” with the earliest shooting time on Day=“5” (the fifth day) of the month is described.

If there is at least one other calendar control file corresponding to a past month previous to that of the calendar control file concerned, a calendar control file corresponding to the past and latest month before the month of the calendar control file concerned is listed in the calendar control file.

Further, if there is at least one other calendar control file corresponding to a future month subsequent to the month of the calendar control file concerned, a calendar control file corresponding to the future and earliest month after the month of the calendar control file concerned is listed in the calendar control file.

For example, in the calendar control file “2004_{—}01.CAL,” a file “/CALENDAR/2004_{—}02.CAL” corresponding to February 2004 is listed as a calendar control file corresponding to the future and earliest month after the month of the calendar control file concerned. Note that, since there is no calendar control file corresponding to any past month before the month of the calendar control file concerned, no calendar control file corresponding to the past and latest month is listed in “2004_{—}01.CAL.”

On the other hand, for example, a calendar control file “/CALENDAR/2004_{—}01.CAL” relating to January 2004 is listed in “2004_{—}02.CAL” as a calendar control file corresponding to the past and latest month before the month of the calendar control file concerned. Then, the calendar control file “/CALENDAR/2004_{—}06.CAL” relating to June 2004 is listed as a calendar control file corresponding to the future and earliest month after the month of the calendar control file concerned.

Here, the calendar file corresponding to the past and latest month before the month of the calendar control file concerned is called a “Prev” parameter, while the calendar control file corresponding to the future and earliest month after the month of the calendar control file concerned is called a “Next” parameter.

Further, if there is an album control file describing a list of image files shot in the same month as that of the calendar control file concerned, the album control file is listed in the calendar control file.

For example, in the calendar control file “2004.01.CAL,” image file names “/DCIM/100OLYMP/P1010001.JPG” and “/DCIM/100OLYMP/P1050003.JPG” are described as a list of representative images. Here, “/DCIM/100OLYMP/P1010001.JPG” is described in the album control file “ALBUM_{—}01.ALB,” while “/DCIM/100OLYMP/P1050003.JPG” is described in the album control file “ALBUM_{—}02.ALB.” Therefore, “/ALBUM/ALBUM_{—}01.ALB” and “/ALBUM/ALBUM_{—}02.ALB” are described in-the calendar control file “2004.01.CAL” as a list of album control files.

Here, the list of album control files is called an “ALBUM” parameter.

Next, the outline of calendar display operation performed based on the calendar control file will be described.

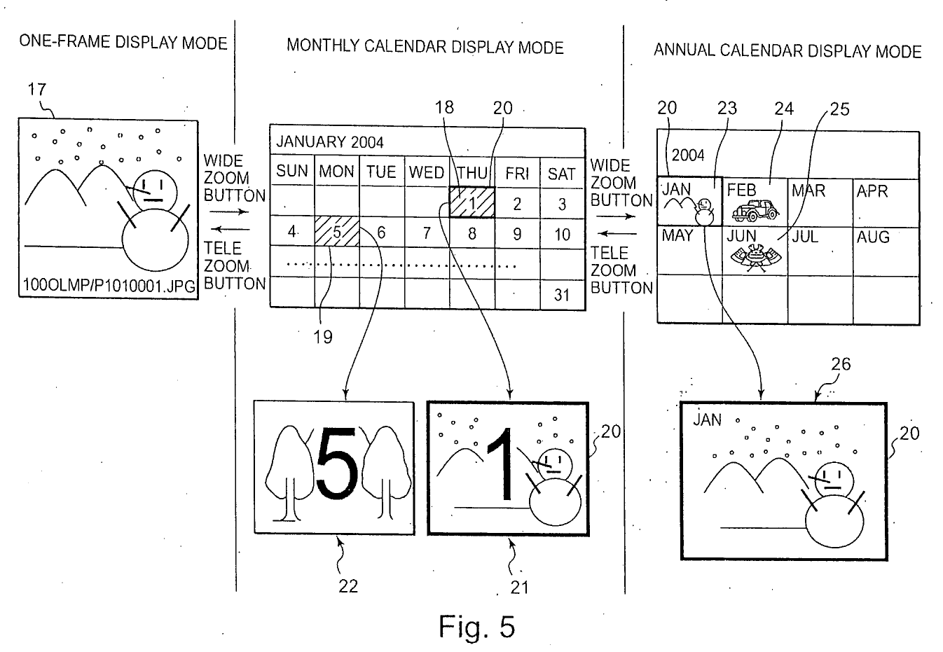

FIG. 5 is a diagram for explaining the outline of the calendar display operation.

For example, when the user performs predetermined operations to the operation part 15 to instruct the one-frame display mode for displaying an image on a frame basis, the digital camera becomes one-frame display mode. In the one-frame display mode, the latest shot frame is set as the display frame. Then, image data corresponding to the display frame is read from the removable memory card 9, and an image based on the image data is displayed on the built-in LCD 12.

After that, in the one-frame display mode, the display frame is switched each time the user operates the cross-shaped cursor button. Specifically, the previous frame is set as the display frame at each press of the Left key, and the following frame is set as the display frame at each press of the Right key. When the user presses the Up key, a frame ten frames before the current display frame is set as the display frame, while when the user presses the Down key, a frame ten frames after the current display frame is set as the display frame. Then, image data corresponding to the display frame is read from the removable memory card 9 each time the user switches the display frame, and an image based on the image data is displayed on the built-in LCD 12. If there is no frame one frame or ten frames before the current display frame, the top frame is set as the display frame, while if there is no frame one frame or ten frames after the current display frame, the last frame is set as the display frame.

When the user presses the Wide zoom button in the one-frame display mode, the mode is switched to a monthly calendar display mode for displaying a calendar on a monthly basis, for example, January, February, etc. In this case, a calendar for a month including the shooting date of the image in the last display frame in the one-frame display mode is displayed based on the calendar control file corresponding to the month concerned.

For example, as shown in FIG. 5, if an image 17 in the last frame displayed in the one-frame display mode is “100OLYMP/P1010001.JPG,” since the shooting date of the image 17 is Jan. 1, 2004, the calendar control file “2004_{—}01.CAL” corresponding to January 2004 is read from the removable memory card 9. Then, the monthly calendar for January 2004 is displayed based on the calendar control file.

During the monthly calendar display, image data of a representative image file is read from the removable memory card 9 based on the list of representative image files described on a daily basis in the calendar control file corresponding to the month to be displayed. Then, an image based on the image data is displayed on the calendar in an area of the day related to the file name of the representative image file (that is, corresponding to the shooting date of the image).

In the example of FIG. 5, “/DCIM/100OLYMP/P1010001.JPG” corresponding to the first day of the month and “/DCIM/100OLYMP/P1050003.JPG” corresponding to the fifth day of the month are contained in the list of representative image files described on a daily basis in the calendar control file “2004_{—}01.CAL” corresponding to January 2004 (see FIG. 4). Based on the list, “/100OLYMP/P1010001.JPG” and “/100OLYMP/P1050003.JPG” are read from the removable memory card 9. As a result, an image 18 based on “/100OLYMP/P1010001.JPG” is displayed in the area of the first day on the monthly calendar, and an image 19 based on “/100OLYMP/P1050003.JPG” is displayed in the area of the fifth day on the monthly calendar.

Thus, the one-frame display mode is switched to the monthly calendar display mode, displaying the monthly calendar for the month including the shooting date of the image in the last display frame displayed in the one-frame display mode. At this moment, a cursor frame is displayed in the area corresponding to the shooting date of the image in the last frame displayed in the one-frame display mode.

In the example of FIG. 5, since the shooting date of the image 17 in the last display frame in the one-frame display mode is Jan. 1, 2004, a cursor frame 20 is displayed in the area of the fist day of the month.

Indicated by reference numerals 21 and 22 in FIG. 5 are enlarged views of the area of the first day including the cursor frame 20 and the area of the fifth day, respectively.

After that, in the monthly calendar display mode, the cursor frame 20 is moved each time the user operates the cross-shaped cursor button. Specifically, when the user presses the Left key, the cursor frame 20 is moved to an area corresponding to the shooting date of the past and latest image file before the day for which the cursor frame 20 was displayed. When the user presses the Right key, the cursor frame 20 is moved to an area corresponding to the shooting date of the future and earliest image file after the day for which the cursor frame 20 was displayed. When the user presses the Up key, the cursor frame 20 is moved to an area corresponding to the shooting date of the past and latest image file before the month including the day for which the cursor frame 20 was displayed. When the user presses the Down key, the cursor frame 20 is moved to an area corresponding to the shooting date of the future and earliest image file after the month including the day for which the cursor frame 20 was displayed.

Note that, if there is no corresponding image file at the time of any key operation of the cross-shaped cursor button, the cursor frame is not moved. However, the present invention is not limited to the above-mentioned operations of the cross-shaped cursor button. For example, the cursor frame can be moved to an area of an image file with the latest shooting date at the press of the Left or Up key. On the other hand, the cursor frame can be moved to an area of an image file with the earliest shooting date at the press of the Right or Down key.

As will be described in detail later, such operations of the cross-shaped cursor button are performed based on the list of representative image files described in the calendar control file and the file name of the calendar control file.

Further, when the user presses the Tele zoom button in the monthly calendar display mode, the mode is switched to the one-frame display mode again. In this case, the image corresponding to the image file representative of all the image files on the day for which the cursor frame 20 was displayed last time in the monthly calendar display mode is displayed as an image in the display frame.

On the other hand, the user presses the Wide zoom button in the monthly calendar display mode, the mode is switched to the annual calendar display mode for displaying an annual calendar such as for 2004, 2005, etc. In this case, an annual calendar for a year is displayed based on the calendar control file corresponding to the year including the day of the month for which the cursor frame 20 was displayed last time in the monthly calendar display mode.

In the example of FIG. 5, since the day for which the cursor frame 20 was displayed last time in the monthly calendar display mode is Jan. 1, 2004, “2004_{—}01.CAL,” “2004_{—}02.CAL,” and “2004_{—}06.CAL” are read from the removable memory card 9 as the calendar control files corresponding to the months included in 2004. Then, based on these calendar control files, an annual calendar for 2004 is displayed.

During the annual calendar display, image data of a representative image file with the earliest shooting date in each calendar control file is read from the removable memory card 9 based on the list of representative image files in each of the read calendar control file. Then, an image based on the read image data is displayed in an area of the month related to the calendar control file (that is, corresponding to the shooting month of the image).

In the example of FIG. 5, “/100OLYMP/P1010001JPG” is read from the removable memory card 9 based on the representative image file “/DCIM/100OLYMP/P1010001.JPG” with the earliest shooting date in “2004_{—}01.CAL.” Then, based on “/100OLYMP/P1010001.JPG,” an image 23 is displayed in the area of January on the annual calendar. Similarly, based on “/DCIM/101OLYMP/P2010001.JPG” with the earliest shooting date in “2004_{—}02.CAL,” an image 24 is displayed in the area of February. Further, based on “/DCIM/101OLYMP/P6220002.JPG” with the earliest shooting date in “2004_{—}06.CAL,” an image 25 is displayed in the area of June.

In the embodiment, the image displayed in the area of a month is an image with the earliest shooting date in the month. However, the present invention is not limited thereto. For example, it can be the latest image file in the month.

Further, when the mode is switched from the monthly calendar display mode to the annual calendar display mode, the annual calendar for the year including the day for which the cursor frame was displayed last time in the monthly calendar display mode is displayed. At this moment, the cursor frame is displayed in the area of the month including the day for which the cursor frame was displayed last time in the monthly calendar display mode.

In the example of FIG. 5, since the day for which the cursor frame 20 was displayed last time in the monthly calendar display mode is Jan. 1, 2004, the cursor frame 20 is displayed in the area of January.

Indicated by a reference numeral 26 in FIG. 5 is an enlarged view of the January area including the cursor frame 20 on the annual calendar for 2004.

After that, in the annual calendar display mode, the cursor frame is moved each time the user operates the cross-shaped cursor button. Specifically, when the user presses the Left key, the cursor frame is moved to an area corresponding to an image file with the past and latest shooting date before the month for which the cursor frame was displayed last time. When the user presses the Right key, the cursor frame is moved to an area corresponding to an image file with the future and earliest shooting date after the month for which the cursor frame was displayed. When the user presses the Up key, an annual calendar for a year containing an image file with the past and latest shooting date before the year including the month for which the cursor frame was displayed is displayed, and the cursor frame is moved to an area corresponding to the image file with the latest shooting date in the annual calendar. When the user presses the Down key, an annual calendar for a year containing an image file with the future and earliest shooting date after the year including the month for which the cursor frame was displayed is displayed, and the cursor frame is moved to an area corresponding to the image file with the earliest shooting date in the annual calendar.

Note that, if there is no corresponding image file at the time of any key operation of the cross-shaped cursor button, the cursor frame is not moved. However, the present invention is not limited to the above-mentioned operations of the cross-shaped cursor button. For example, the cursor frame can be moved to an area of the month corresponding to the image file with the latest shooting date at the press of the Left or Up button. On the other hand, the cursor frame can be moved to an area of the month corresponding to the image file with the earliest shooting date at the press of the Right or Down key.

As will be described in detail later, such operations of the cross-shaped cursor button are performed based on the list of representative image files and the list of calendar control files described in each calendar control file.

Further, when the user presses the Tele zoom button in the annual calendar display mode, the mode is switched to the monthly calendar display mode again. Then, based on the calendar control file corresponding to the month for which the cursor frame was displayed last time in the annual calendar display mode. Further, the cursor frame is displayed in an area corresponding to the image with the earliest shooting date in the month for which the cursor frame was displayed last time in the annual calendar display mode.

Next, the outline of operation for creating and recording, or updating the album control file, and the outline of operation for updating the calendar control file based on the operation for the album control file (hereinafter, both operations are collectively called “album registration operation”) will be described.

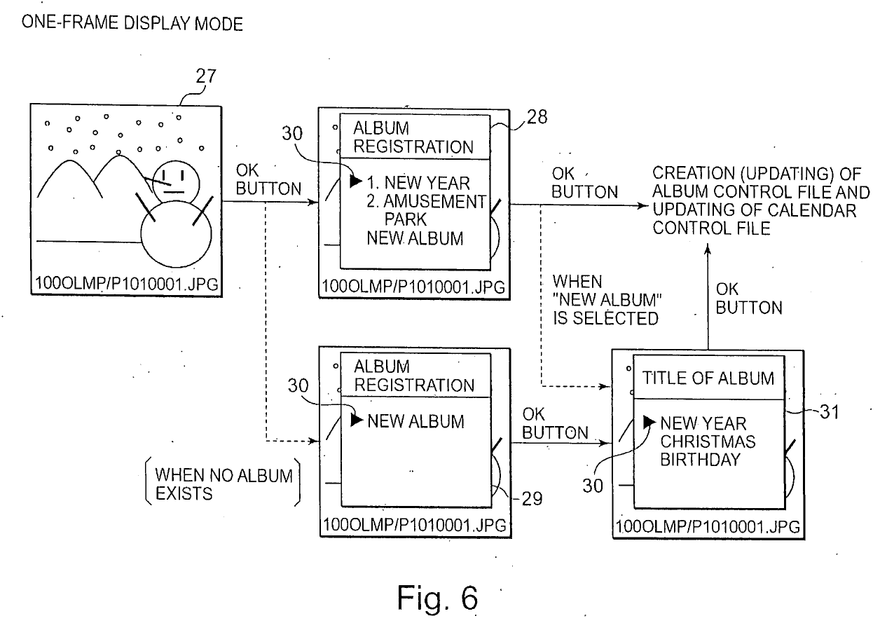

FIG. 6 is a diagram for explaining the outline of the album registration operation.

As shown in FIG. 6, when registering an image in an album, the user displays a desired image to be registered in the album with the operations of the cross-shaped cursor button in the one-frame display mode, and when the desired image is displayed, the user presses the OK button.

FIG. 6 shows a case where the user presses the OK button when an image 27 with the image file name of “100OLYMP/P1010001.JPG” is displayed.

In response to the press of the OK button, a registration destination album selecting menu (registration destination album selecting screen) 28 for showing a list of albums selectable as a registration destination is displayed. On the registration destination album selecting menu 28, the album numbers and titles in album control files recorded on the removable memory card 9 are displayed. An item “New Album” is also displayed to allow the user to create a new album and to register an image in the new album.

In the example of FIG. 6, “ALBUM_{—}01.ALB” and “ALBUM_{—}02.ALB” shown in FIG. 3 are recorded on the removable memory card 9. In other words, the item with the album number “1” and the album title “New Year,” the item with the album number “2” and the album title “Amusement Park,” and the item indicating “New Album” are displayed on the registration destination album selecting menu 28.

Note that, if no album control file is recorded on the removable memory card 9, a registration destination album selecting menu 29 with only the item indicating “New Album” is displayed.

Then, the user moves a cursor 30 to a desired album title with the operations of the Up and Down keys on the registration destination album selecting menu 28, and when the cursor comes to the desired album title, the user presses the OK button. As a result, the album title is selected and the image is registered in the album with the selected album title. Specifically, an image file name corresponding to the image is listed in the album control file with the selected album title, and the album control file is updated.

In the example of FIG. 6, the user moves the cursor 30 to “New Year” on the registration destination album selecting menu 28, and pressed the OK button. As a result, “/DCIM/100OLYMP/P1010001.JPG” as a list of image files including the image file “/100OLYMP/P1010001.JPG” is described in the album control file “ALBUM_{—}01.CAL” with the album title “New Year,” and the “ALBUM_{—}01.ALB” is updated.

Alternatively, the user can move the cursor 30 to “New Album” on the registration destination album selecting menu 28 (or 29), and press the OK button. In this case, an album title selection menu (album title selection screen) 31 for showing a list of album titles that the user can newly create is displayed. The user moves the cursor 30 to a desired album title on the album title selection menu 31 with the operations of the Up and Down keys, and when the cursor comes to the desired album title, the user presses the OK button. As a result, the album title is selected, an album control file with the selected album title is created, and the album number and image file name of the image are listed in the album control file created. The album control file is then recorded on the removable memory card 9. Note that the album number is set not to overlap any of the album numbers of the album control files already recorded on the removable memory card 9.

For example, if the user selects “Birthday” as the album title from the album title selection menu 31, an album control file with the album title “Birthday” is created. In this case, album number “3” and “/DCIM/100OLYMP/P1010001.JPG” as a list of image files including the image file “/100OLYMP/P1010001.JPG” are listed in the album control file and recorded on the removable memory card 9.

Thus, when the album control file is updated, or created and recorded, a calendar control file corresponding to the same shooting month as that of the image file listed in the album control file is searched for. If the calendar control file is already recorded on the removable memory card 9, the album control file is listed in the calendar control file as an “ALBUM” parameter, and the calendar control file is updated.

Next, the outline of switching operation from calendar display to album viewing performed based on the calendar control file and the album control file will be described.

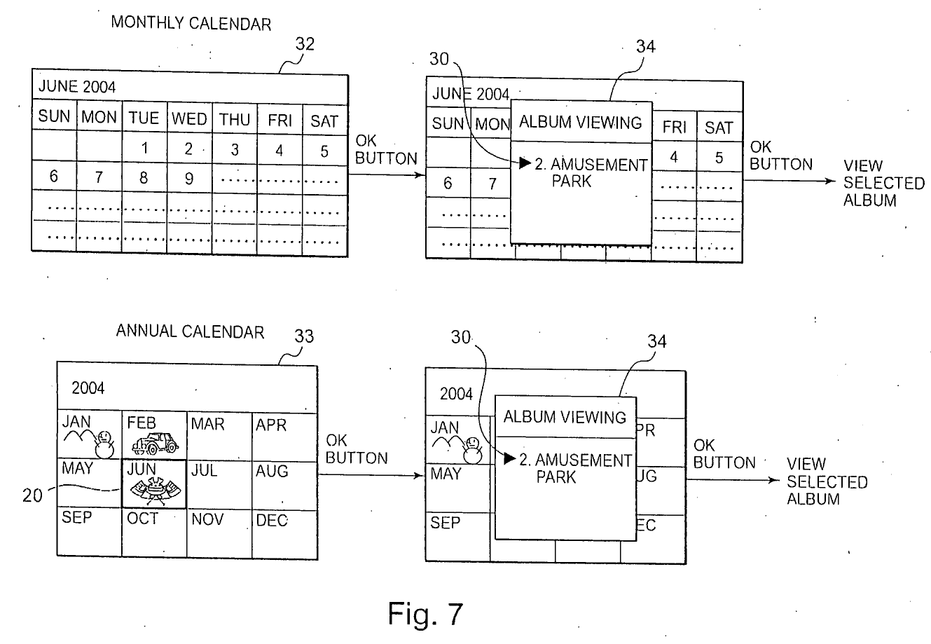

FIG. 7 is a diagram for explaining the outline of the switching operation from calendar display to album viewing.

As shown in the upper part of FIG. 7, when a monthly calendar 32 displaying images on a daily basis is displayed, the user presses the OK button to view an album in which an image shot in the month of the monthly calendar 32 is registered. On the other hand, as shown in the lower part of FIG. 7, when an annual calendar 33 displaying images on a monthly basis is displayed, the user presses the OK button to view an album in which an image shot in the month with the cursor frame 20 on the annual calendar 33 is registered.

In the example of FIG. 7, suppose that the user presses the OK button when the monthly calendar 32 for June 2004 is displayed or when the cursor frame 20 is in the area of June on the annual calendar 33 for 2004.

As a result, a viewing album selection menu (viewing album selection screen) 34 for showing a list of album numbers and album titles of the album control files is displayed based on the “ALBUM” parameter(s) described in the calendar control file corresponding to the month of the monthly calendar 32. In the latter case, the viewing album selection menu 34 is displayed based on the “ALBUM” parameter(s) described in the calendar control file corresponding to the month for which the cursor frame 20 is set on the annual calendar 33.

In the example of FIG. 7, the viewing album selection menu 34 showing the album number “2” and the album title “Amusement Park” of the album control file “ALBUM_{—}02.ALB” is displayed based on the “ALBUM” parameter described in the control file “2004_{—}06.CAL” related to June 2004.

The user operates the Up and Down keys on the album selection menu 34 to move the cursor 30, and when the cursor comes to a desired album title, the user presses the OK button. As a result, the album title is selected, and the viewing of images in the album is started based on the list of image files described in the album control file with the album title selected.

In the example of FIG. 7, since only the album title “Amusement Park” is selectable on the viewing album selection menu 34, the user presses the OK button on the album title. As a result, the image “/100OLYMP/P1050003.JPG” and the image “/101OLYMP/P6220002.JPG” can be displayed based on the list of image files “/DCIM/100OLYMP/P1050003.JPG” and “/DCIM/101OLYMP/P6220002.JPG” described in the album control file “ALBUM_{—}02.ALB” with the album title “Amusement Park” to allow the user to view these images from the album.

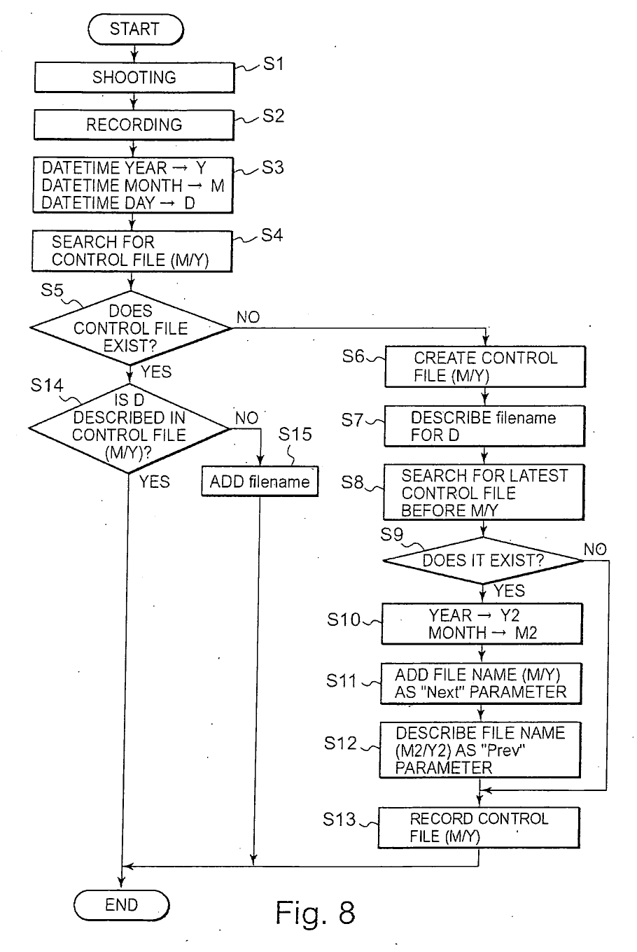

Next, the operation related to the registration of the calendar control file used for the calendar display operation, and the calendar display operation described above with respect to FIG. 5 will be described in further detail with reference to the flowcharts of FIGS. 8 through 12.

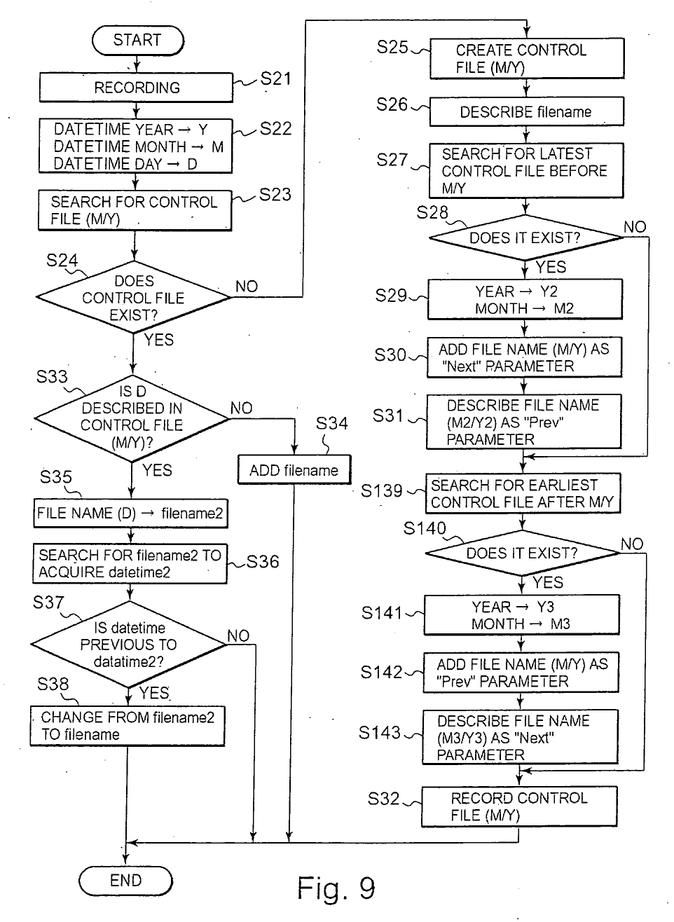

First, the operation related to the registration of the calendar control file will be described with reference to FIGS. 8 and 9.

FIG. 8 is a flowchart showing the operation related to the registration of the calendar control file performed when the user shoots a photo and records an image file on the removable memory card 9.

As shown in FIG. 8, when the user instructs shooting in a shooting mode, the digital camera performs shooting routines (Step (hereinafter simply abbreviated as “S”) 1). Then, image data of the image shot is recorded as an image file on the removable memory card (S2).

The shooting date and time (datetime) of the image file is set in the form of Year=Y, Month=M, and Day=D (S3). Then, the removable memory card 9 is searched for a calendar control file relating to the month M in the year Y (S4), and it is determined whether the calendar control file exists (S5).

If the determination result in S5 is NO, a calendar control file corresponding to the month M in the year Y is created. In other words, a calendar control file describing that the calendar control file corresponds to the month M in the year (“Year”=Y and “Month”=M) is created (S6). Then, a file name (filename) including the path to the image file recorded in S2 is listed in the calendar control file as the file name of a representative image file on the day D (S7). Then, the removable memory card 9 is searched for a calendar control file corresponding to the past and latest month before the month M in the year Y (S8). Then, it is determined whether the calendar control file exists (S9).

If the determination result in S9 is YES, the year and the month of the calendar control file determined to exist in S9 are set to Y2 and M2, respectively (S10). The file name of the calendar control file corresponding to the month M in the year Y is added to the calendar control file corresponding to the month M2 in the year Y2 as a calendar control file list (“Next” parameter) relating to the future and earliest month after the month of the calendar control file concerned (S11). Then, the file name of the calendar control file corresponding to the month M2 in the year Y2 is described in the calendar control file corresponding to the month M in the year Y as a calendar control file list (“Prev” parameter) relating to the past and latest month before the month of the calendar control file concerned (S12). After that, the calendar control file corresponding to the month M in the year Y is recorded on the removable memory card 9 (S13), and the flow is ended.

On the other hand, if the determination result in S9 is NO, the calendar control file corresponding to the month M in the year Y is recorded on the removable memory card 9 as it is (S13), and the flow is ended.

Further, if the determination result in S5 is YES, it is then determined whether the file name of a representative image file on the day D is listed in the calendar control file corresponding to the month M in the year Y (S14).

If the determination result in S14 is NO, the file name (filename) including the path to the image file recorded in S2 is added to the calendar control file corresponding to the month M in the year Y as the representative image file name on the day D (S15), and the flow is ended. On the other hand, if the determination result in S14 is YES, the flow is ended in this step.

FIG. 9 is a flowchart showing the operation related to the registration of the calendar control file performed when an image file from an external apparatus is recorded on the removable memory card 9.

As shown in FIG. 9, the image file is sent from the external apparatus such as a PC connected to the digital camera by a USB cable or the like through the external I/F16, and recorded on the removable memory card 9 (S21). Upon receipt of the image file, the digital camera initiates processing starting from S22.

The processing starting from S22 is substantially the same as the processing starting from S3 in FIG. 8. A different point is that, in the flow of FIG. 8, S13 is performed after S12 or if NO in S9 and the flow is ended if YES in S14, while in the flow of FIG. 9, processing from S139 to S143 is further performed after S31 (corresponding to S12) or if NO in S28 (corresponding to S9) before S32 (corresponding to S13) is performed. Another different point is that, in the flow of FIG. 9, processing from S35 to S38 is further performed after YES in S33 (corresponding to S14).

In other words, after S31 or if NO in S28, the removable memory card 9 is searched for a calendar control file corresponding to the future and earliest month after the month M in the year Y (S139). It is then determined whether the calendar control file exists (S140).

If the determination result in S140 is YES, the year and the month of the calendar control file determined to exist in S140 are set to Y3 and M3, respectively (S141). The file name of the calendar control file corresponding to the month M in the year Y is added to the calendar control file corresponding to the month M3 in the year Y3 as a calendar control file list (“Prev” parameter) relating to the past and latest month before the month of the calendar control file concerned (S142). Then, the fife name of the calendar control file corresponding to the month M3 in the year Y3 is described in the calendar control file corresponding to the month M in the year Y as a calendar control file list (“Next” parameter) relating to the future and earliest month after the month of the calendar control file concerned (S143). Then, the calendar control file corresponding to the month M in the year Y is recorded on the removable memory card 9 (S32), and the flow is ended. On the other hand, if the determination result in S140 is NO, the calendar control file corresponding to the month M in the year Y is recorded on the removable memory card 9 as it is (S32), and the flow is ended.

The reason for performing the processing starting from S139 after S31 or if NO in S28 is that, when an image file from the external apparatus is recorded on the removable memory card 9, the shooting date and time of the image file from the external apparatus could be earlier than that of the image file already recorded on the removable memory card 9.

Further, in the flow, if YES in S33, “filename2” including the path to the representative image file on the day D and listed in the calendar control file corresponding to the month M in the year Y is acquired (S35). Then, the removable memory card 9 is searched for the file name of the-representative image file to acquire the shooting date and time (datetime2) of the representative image file (S36). It is then determined whether the shooting time in the shooting date and time (datetime) of the image file recorded in S21 on the removable memory card 9 is earlier than the shooting time in the date and time (datetime2) of the representative image file acquired in S36 (S37).

If the determination result in S37 is YES, the file name “filename2” including the path to the image file described in the calendar control file corresponding to the month M in the year Y as the file name of the representative image file on the day D is changed to the file name “filename” including the path to the image file recorded in S21 (S38). After that, the flow is ended. On the other hand, if NO in S37, the flow is ended in this step.

The reason for performing the processing starting from S35 if YES in S33 is that, when an image file sent from the external apparatus and recorded on the removable memory card 9 has the same shooting date as the image file already recorded on the removable memory card 9, the shooting time of the image file from the external apparatus could be earlier than that of the image file already recorded on the removable memory card 9.

In the embodiment, if there are two or more image files with the same shooting date, the file name of an image file with the latest shooting time can also be set as the file name of the representative image file on that day. In this case, the flow is configured to perform S38 if NO in S37, while the flow is ended without performing S38 if YES in S37.

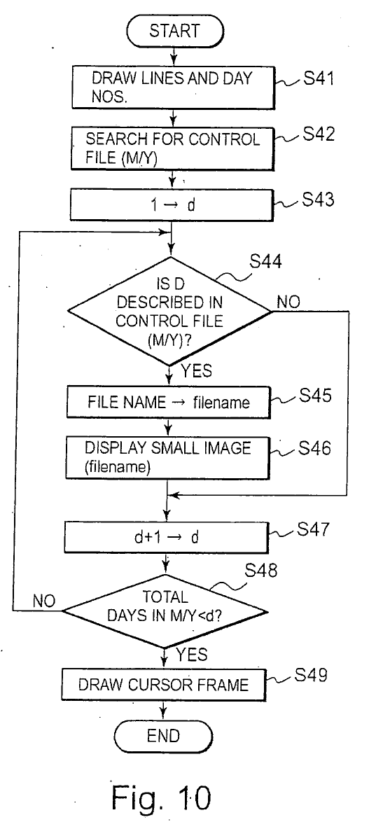

Next, the operation of calendar display performed when the mode is changed from the one-frame display mode to the monthly calendar display mode at the press of the Wide zoom button, or from the annual calendar display mode to the monthly calendar display mode at the press of the Tele zoom button will be described wit reference to FIG. 10.

FIG. 10 is a flowchart relating to the calendar display operation when the mode is changed to the monthly calendar display mode.

As shown in FIG. 10, when the Wide zoom button is pressed in such a state that an image dated M/D/Y (where M=month, D=day, and Y=year) is displayed in the one-frame display mode, lines and day numbers for a monthly calendar for the month M in the year Y are drawn in the VRAM 10 including the shooting date of the image (S41). Alternatively, when the Tele zoom button is pressed in such a state that an annual calendar for the year Y is displayed in the annual calendar display mode with the cursor frame in an area of the month M containing an image dated M/D/Y in the area (where the day D is the earliest shooting date in all images shot in the month M, the year Y), lines and day numbers for a monthly calendar for the month M in the year Y are first drawn in the VRAM 10 including the shooting date of the image being displayed in the area with the cursor frame (S41). Thus, the monthly calendar for the month M in the year Y is displayed on the built-in LCD 12. At this moment, however, the image is not displayed on the monthly calendar yet.

Then, the removable memory card 9 is searched for a calendar control file corresponding to the month Y in the year Y (S42). Then, “1” is set to d (1→d) (S43) to determine whether the file name of a representative image file on the day d is listed in the calendar control file corresponding to the month M in the year Y (S44).

If YES in S44, “filename” including the path to a representative image file on the day d is acquired (S45). Then, image data of the representative image file on the day d is read, and a small image based on the image data of the representative image on the day d is displayed in the area of the day d on the monthly calendar for the month M in the year Y (S46). Then, d is incremented by one (d+1→d) (S47). On the other hand, if NO in S44, the procedure goes to S47 to increment d by one (d+1→d).

Following S47, it is determined whether d exceeds the total number of days in the month M, the year Y (S48). If the determination result is NO, the procedure returns to S44. Since the above-mentioned processing is repeated from d=1 up to d=total number of days in the month M, the year Y, small images are displayed in all the day areas on the monthly calendar for the month M in the year Y as long as there is a representative image file on each day.

Then, if YES in S48, a cursor frame is drawn in an area of the VRAM10 corresponding to the area of the day D on the monthly calendar for the month M in the year Y (S49), and the flow is ended. When the cursor frame is drawn, the cursor frame appears in the area of the day D on the monthly calendar for the month M in the year Y.

According to the flow, when the mode is changed to the monthly calendar display mode, a calendar control file corresponding to the month to be displayed is searched for, and image data of representative image files are read based on a list of representative image files described in the calendar control file. This makes it unnecessary to search for a representative image file from all image files recorded on the removable memory card 9. Therefore, since the processing time required to search for a representative image file can be reduced to a large extent, the monthly calendar display operation for displaying representative images on a daily basis can be performed smoothly at high speed.

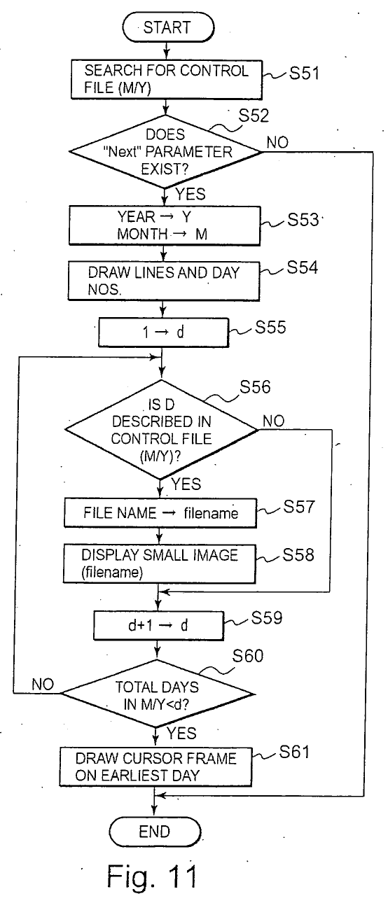

Next, the calendar display operation when the cursor frame is moved in the monthly calendar display mode at the press of the Down key will be described with reference to FIG. 11.

FIG. 11 is a flowchart relating to the calendar display operation.

As shown in FIG. 11, when the Down key is pressed in such a state that the monthly calendar for the month M in the year Y is displayed, a calendar control file corresponding to the month M in the year Y is searched for (S51). It is then determined whether a “Next” parameter is described in the calendar control file corresponding to the month M in the year Y, that is, whether a calendar control file corresponding to the future and earliest month after the month M in the year Y is listed in the calendar control file concerned (S52).

If YES in S52, the calendar control file listed as the “Next” parameter is read from the removable memory card 9 based on the calendar control file list (“Next” parameter) in the calendar control file concerned. Then, the year and the month are acquired from the calendar control file specified by the “Next” parameter, and “Y” is set for the year and “M” is set for the month (S53). Then, lines and day numbers for the monthly calendar for the month M in the year Y are drawn in the VRAM 10 (S54). Thus, the monthly calendar for the month M in the year Y is displayed on the built-in LCD 12. At this moment, however, the image is not displayed on the monthly calendar yet.

The following processing from S55 to S60 is the same as the above-mentioned processing from S43 to S48 in FIG. 10.

Since the above-mentioned processing is repeated from d=1 up to d=total number of days in the month M, the year Y, small images are displayed in all the day areas on the monthly calendar for the month M in the year Y as long as there is a representative image file on each day.

Then, if YES in S60, a cursor frame is drawn in an area of the VRAM10 corresponding to the area of the day that is the earliest shooting date in the list of representative image files described in the calendar control file corresponding to the month M in the year Y (S61), and the flow is ended. When the cursor frame is drawn, the cursor frame appears on the monthly calendar for the month M in the year Y in the area of the day in which the representative image having the earliest shooting date in the month M is displayed.

On the other hand, if NO in S52, the flow is ended in this step. Note that the above-mentioned processing from S54 to S61 can also be performed based on the calendar control file corresponding to the earliest month recorded on the removable memory card 9 to display a monthly calendar for the earliest month.

According to the flow, when the cursor frame is moved at the press of the Down key, a calendar control file corresponding to the future and earliest month after the month of the calendar control file concerned is read based on the “Next” parameter described in the calendar control file corresponding to the month being displayed before the instruction to move the cursor frame. Then, a monthly calendar for the month after the instruction is displayed based on the read calendar control file. Therefore, even if the displayed month is changed according to the instruction to move the cursor frame, the monthly calendar display operation for displaying a monthly calendar for another month with representative images displayed on a daily basis can be performed smoothly at high speed.

Although the above-mentioned flow is to perform the operation when the cursor frame is moved at the press of the Down key, a similar flow is applied when the cursor frame is moved at the press of the Up key. In this case, however, the processing is performed using the “Prev” parameter instead of the “Next” parameter. Further, the cursor frame is drawn in an area of the VRAM 10 corresponding to the area of the day that is the latest shooting date in the list of representative image files described in the calendar control file corresponding to the month M in the year Y.

Further, when the cursor frame is moved at the press of the Left key, the following processing is performed depending on whether a representative image file with the shooting date previous to the day for which the cursor frame was displayed is contained in the list of representative image files in the calendar control file corresponding to the month being displayed before the instruction to move the cursor frame. Namely, when at least one corresponding representative image file is listed, the cursor frame is displayed in an area corresponding to the representative image file with the past and latest shooting date before the day for which the cursor frame was displayed. On the other hand, when no corresponding representative image file is listed, it is further determined whether a “Prev” parameter is listed in the calendar control file corresponding to the month being displayed before the instruction to move the cursor frame. Only when the “Prev” parameter is listed, a corresponding calendar control file is read. Then, the cursor frame is displayed in an area corresponding to the image file with the latest shooting date in the list of representative image files described in the read calendar control file. In this case, however, since the displayed month also needs changing, the cursor frame is displayed after the above-mentioned processing from 41 to S48 in FIG. 10 is performed on the month of the calendar control file specified by the “Prev” parameter.

Similarly, when the cursor frame is moved at the press of the Right key, the following processing is performed depending on whether a representative image file with the shooting date subsequent to the day for which the cursor frame was displayed is contained in the list of representative image files in the calendar control file corresponding to the month being displayed before the instruction to move the cursor frame. Namely, when at least one corresponding representative image file is listed, the cursor frame is displayed in an area corresponding to the representative image file with the future and earliest shooting date after the day for which the cursor frame was displayed. On the other hand, when no corresponding representative image file is listed, it is further determined whether a “Next” parameter is listed in the calendar control file corresponding to the month being displayed before the instruction to move the cursor frame. Only when the “Next” parameter is listed, a corresponding calendar control file is read. Then, the cursor frame is displayed in an area corresponding to the image file with the earliest shooting date in the list of representative image files described in the read calendar control file. In this case, however, since the displayed month also needs changing, the cursor frame is displayed after the above-mentioned processing from 41 to S48 in FIG. 10 is performed on the month of the calendar control file specified by the “Next” parameter.

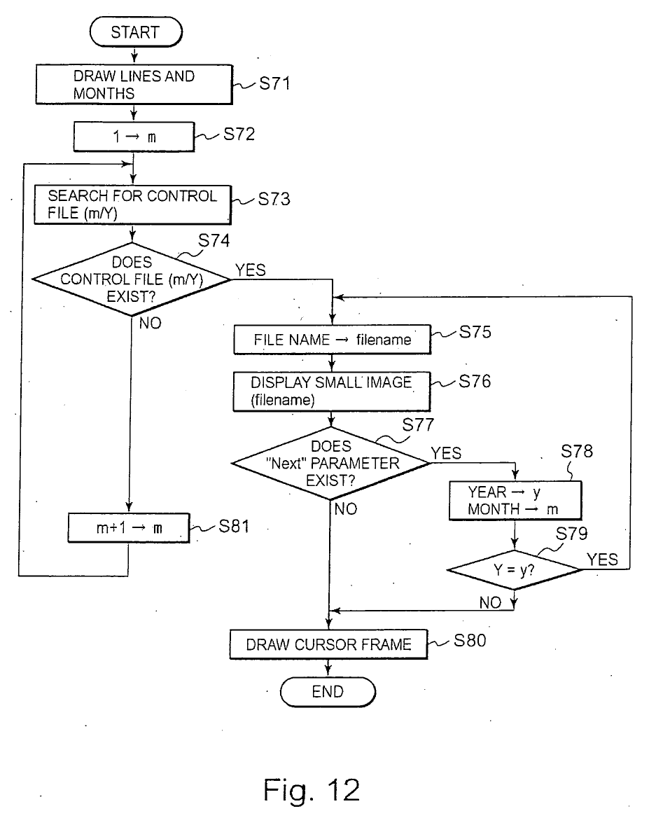

Next, the calendar display operation performed when the mode is changed from the monthly calendar display mode to the annual calendar display mode at the press of the Wide zoom button will be described with reference to FIG. 12.

FIG. 12 is a flowchart relating to the calendar display operation when the mode is changed to the annual calendar display mode.

As shown in FIG. 12, suppose that the Wide zoom button is pressed when the monthly calendar for the month M in the year Y is displayed in the monthly calendar display mode with the cursor frame in an area of M/D/Y (where M=month, D=day, and Y=year). In this case, lines and months for an annual calendar are drawn in the VRAM 10 including the shooting date of the image that was displayed in the area of M/D/Y with the cursor frame (S71). Thus, the annual calendar for the year Y is displayed on the built-in LCD 12. At this moment, however, no image is displayed on the annual calendar yet.

Then, “1” is set for m (1→m) (S72), the removable memory card 9 is searched for a control file corresponding to the month m in the year Y (S73), and it is determined whether the calendar control file is exists (S74).

If the determination result in S74 is NO, m is incremented by one (m+1→m) (S81), and the procedure returns to S73 to search for a calendar control file corresponding to the next month.

On the other hand, if the determination result in S74 is YES, “filename2” including the path to the representative image file having the earliest shooting date in the lest of representative image files in the calendar control file corresponding to the month m in the year Y is acquired (S75). Then, image data of the representative image file with the earliest shooting date is read, and a small image based on the image data is displayed in the area of the month m on the annual calendar for the year Y (S76). Then, it is determined whether a “Next” parameter is listed in the calendar control file corresponding to the month m in the year Y, that is, whether a calendar control file corresponding to the future and earliest month after the month m in the year Y is listed in the calendar control file concerned (S77).

If YES in S77, the calendar control file is read based on the “Next” parameter listed in the calendar control file concerned. Then, the year and the month are acquired from the read calendar control file, and “y” is set for the year and “m” is set for the month (S78). It is then determined whether Y=y (S79).

If YES in S79, the procedure returns to S75, repeating the processing starting from S75 for the calendar control file corresponding to the month m in the year Y.

On the other hand, if NO in S79, the procedure goes to S80 to draw a cursor frame in an area of the VRAM 10 corresponding to the area of the month M on the annual calendar for the year Y. After that, the flow is ended. When the cursor frame is drawn, the cursor frame appears on the annual calendar for the year Y in the area of the month M.

According to the flow, when the mode is changed to the annual calendar display mode, calendar control files corresponding to all months in the year to be displayed are searched for. Then, based on each representative image file with the earliest shooting date in the list of representative image files in each calendar control file is read. This makes it unnecessary to search for a representative image file from all image files recorded on the removable memory card 9. Therefore, since the processing time required to search for a representative image file can be reduced to a large extent, the annual calendar display operation for displaying representative images on a monthly basis can be performed smoothly at high speed.

In this annual calendar display mode, when the cursor frame is moved at the press of the Up key, a calendar control file corresponding to the earliest month in the year being displayed before the instruction to move the cursor frame is referred to. Then, only when a “Prev” parameter is listed in the calendar control file, the above-mentioned processing from S71 to S79 in FIG. 12 is performed on the year including the month of the calendar control file specified by the “Prev” parameter. In other words, the cursor frame is displayed in the area of the month of the calendar control file.

Similarly, when the cursor frame is moved at the press of the Down key, a calendar control file corresponding to the latest month in the year being displayed before the instruction to move the cursor frame is referred to. Then, only when a “Next” parameter is listed in the calendar control file, the above-mentioned processing from S71 to S79 in FIG. 12 is performed on the year including the month of the calendar control file specified by the “Next” parameter. In other words, the cursor frame is displayed in the area of the month of the calendar control file.

Further, in this annual calendar display mode, when the cursor frame is moved at the press of the Left key, the calendar control file corresponding to the month for which the cursor frame was displayed before the instruction to move the cursor frame is referred to. Then, only when a “Prev” parameter is listed in the calendar control file, the cursor frame is displayed in the area of the month of to the calendar control file specified by the “Prev” parameter. Note that, if the year being displayed before the instruction is different from the year to be displayed after the instruction, the cursor frame is displayed after the above-mentioned processing from S71 to S79 in FIG. 12 is performed.

Similarly, when the cursor frame is moved at the press of the Right key, the calendar control file corresponding to the month for which the cursor frame was displayed before the instruction to move the cursor frame is referred to. Then, only when a “Next” parameter is listed in the calendar control file, the cursor frame is displayed in the area of the month of the calendar control file specified by the “Next” parameter. Note that, if the year being displayed before the instruction is different from the year to be displayed after the instruction, the cursor frame is displayed after the above-mentioned processing from S71 to S79 in FIG. 12 is performed.

As described above, according to the embodiment, the list of representative image files listed on a daily basis in each calendar control file recorded on the removable memory card 9 and the list of calendar control files described as a “Prev” parameter and/or a “Next” parameter in each calendar control file are referred to. Then, based on these lists, the monthly calendar display operation for displaying representative images on a daily basis and the annual calendar display operation for displaying representative images on a monthly basis can be performed smoothly at high speed.

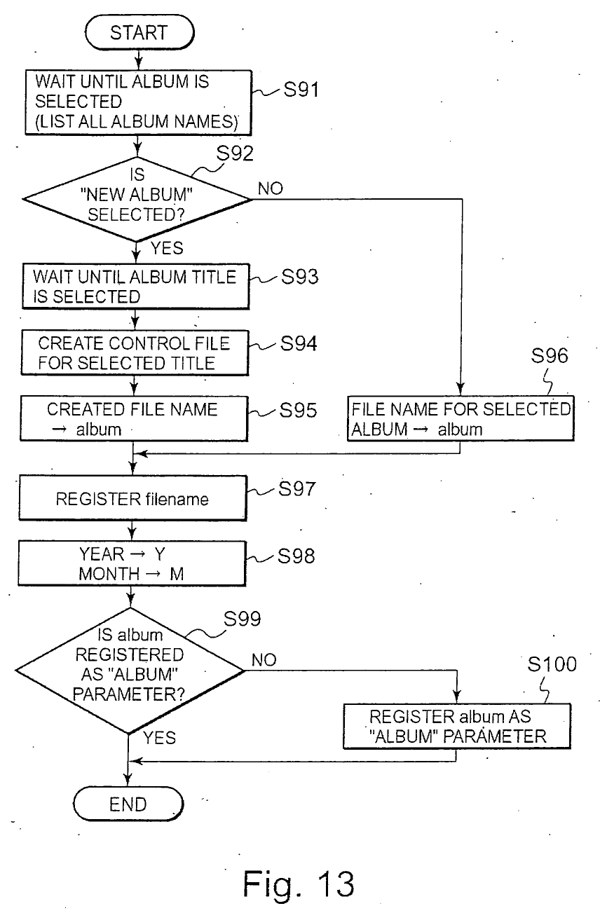

Next, the album registration operation described above with respect to FIG. 6 and the switching operation from calendar display to album viewing described above with respect to FIG. 7 will be described in further detail with reference to flowcharts of FIGS. 13 to 15.

FIG. 13 is a flowchart showing the album registration operation.

As shown in FIG. 13, suppose that the user presses the OK button when a desired image is displayed in the one-frame display mode. In this case, the registration destination album selecting menu including the album number and album title for each album control file recorded on the removable memory card 9 and an optional item “New Album” are displayed, and the procedure waits until the user selects an item from the registration destination album selecting menu (S91).

When the user selects an item from the registration destination album selecting menu, it is determined whether the selected item is “New Album” (S92).

If the determination result in S92 is YES, the album title selection menu showing a list of selectable album titles is displayed, and the procedure waits until the user selects an item from the album title selection menu (S93). When the user selects an item from the album title selection menu, an album control file with the album title selected is created (S94), and “album” is set as the file name of the album control file (S95).

Note that the album control file created in S94 is assigned an album number (a unique album number that does not overlap any of the album numbers of the album control files already recorded on the removable memory card 9).

On the other hand, if the determination result in S92 is NO, “album” is set as the file name of the album control file with the album title selected from the registration destination album selecting menu (S96).

Then, in S97 following S95, “filename” including the path to the image being displayed when the registration destination album selecting menu appears is listed in the album control file, and the album control file is recorded on the removable memory card 9.

On the other hand, in S97 following S96, “filename” including the path to the image being displayed when the registration destination album selecting menu appears is listed in the album control file with the album title selected from the registration destination album selecting menu, and the album control file is updated.

Following S97, the shooting date and time of the image file are acquired, and the shooting year and month are set “Y” and “M” respectively (S98).

Then, it is determined whether “album” is listed as an “ALBUM” parameter in the calendar control file corresponding to month m in year y recorded on the removable memory card 9 (S99).

If the determination result in S99 is YES, the flow is ended in this step, while if NO in S99, “album” is listed as the “ALBUM” parameter in the calendar control file corresponding to the month m in the year y (S100), and the flow is ended.

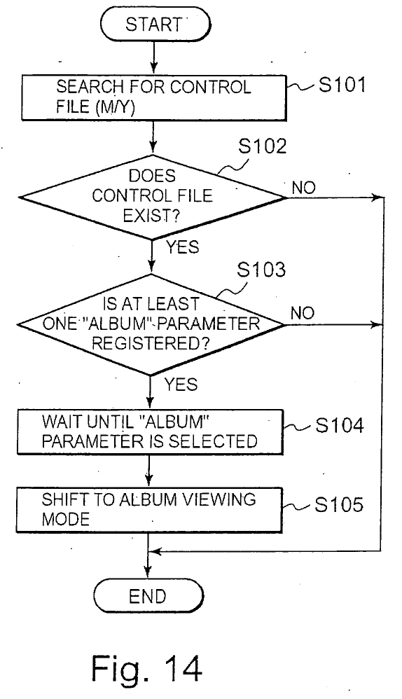

FIG. 14 is a flowchart showing the switching operation from annual calendar display to album viewing.

As shown in FIG. 14, when the OK button is pressed in such a state that the annual calendar for the year Y is displayed with the cursor in the area of the month M, a calendar control file corresponding to the month M in the year Y is searched for (S101). It is then determined whether the calendar control file exists (S102).

If the determination result in S102 is YES, it is then determined whether an “ALBUM” parameter is listed in the calendar control file corresponding to the month M in the year Y (S103).

If the determination result in S103 is YES, the viewing album selection menu including the album title of the album control file as an item is displayed based on the album control file list with the “ALBUM” parameter contained in it, and the procedure waits until the user selects an item from the viewing album selection menu (S104). Following S104, when the user selects an item from the viewing album selection menu, album viewing is started based on the album control file with the album title selected (S105). Specifically, images are displayed based on the list of image files described in the album control file.

On the other hand, if NO in S102, or if No in S103, the flow is ended without performing the subsequent steps.

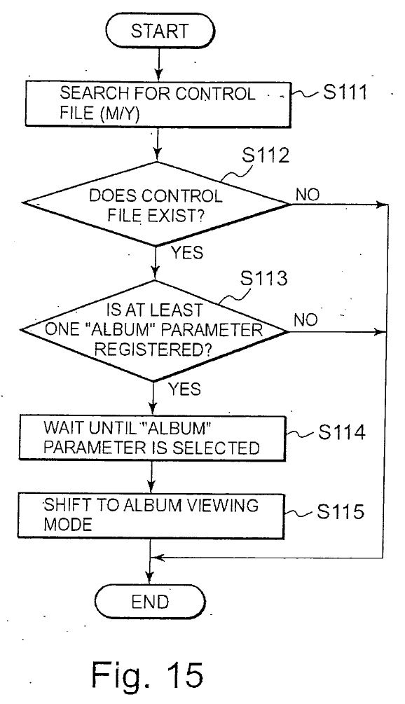

FIG. 15 is a flowchart showing the switching operation from monthly calendar display to album viewing.

This operation is started when the OK button is pressed in such a state that the monthly calendar for the month M in the year Y is displayed, and performed in the same manner as that shown in FIG. 14. In other words, the processing from S101 to S105 in FIG. 14 corresponds to processing from S111 to S115 in FIG. 15.

As described above, according to the embodiment, when the monthly or annual calendar display operation for displaying representative images on the calendar on a daily or monthly basis is performed, the calendar display can be switched easily without closing the calendar display to the viewing of an album in which any one of the representative images is registered.

While there has been shown and described what is considered to be a preferred embodiment of the invention, it will, of course, be understood that various modifications and changes in form or detail could readily be made without departing from the spirit of the invention. It is therefore intended that the invention not be limited to the exact forms described and illustrated, but constructed to cover all modifications that may fall within the scope of the appended claims.

What is claimed is:

1. An image reproducing apparatus comprising:
a system controller; and
a data bus connected to the system controller and accessible to a recording medium,
wherein the system controller has at least
a calendar display function for displaying a calendar based on a calendar control file recorded on the recording medium in units of a first predetermined period and containing at least a list of representative image files in units of a second predetermined period shorter than the first predetermined period so that the representative images will be displayed on the calendar in each area corresponding to the second predetermined period, and
an album viewing function for performing album viewing based on an album control file recorded on the recording medium and containing at least a list of image files for album viewing,
whereby switching from the calendar display to the album viewing is done based on a list of album control files described in the calendar control file and the album control file.

2. The apparatus according to claim 1, wherein the system controller further has an album control file creating function for creating an album control file describing a list of image files for album viewing,
a recording function for recording, on the recording medium, the album control file created by the album control file creating function, and
a first calendar control file updating function which, when an album control file is recorded on the recording medium by the recording function, adds the album control file to a list of album control files in a calendar control file in which the same file name as that of an image file in the album control file is described in the list of representative image files on condition that the calendar control file is recorded on the recording medium.

3. The apparatus according to claim 1, wherein the system controller further has
an album control file updating function for adding an image file for album viewing to the list of image files in an album control file recorded on the recording medium, and
a second calendar control file updating function which, when the image file for album viewing is added to the album control file by the album control file updating function, adds the album control file to a list of album control files in a calendar control file in which the same file name as that of the image file is listed in the list of representative image files on condition that the calendar control file is recorded on the recording medium.

4. The apparatus according to claim 1, wherein
when the calendar display function is performing calendar display for each first predetermined period in such a manner as to display a representative image in each area corresponding to each second predetermined period on the calendar based on the calendar control file recorded on the recording medium, if the calendar display is switched to album viewing, an album control file selected based on the list of album control files in the calendar control file corresponding to the first predetermined period is read to perform album viewing based on the album control file.

5. The apparatus according to claim 1, wherein
when the calendar display function is performing calendar display for a third predetermined period, longer than the first predetermined period, in such a manner as to display a representative image in each area corresponding to each first predetermined period on the calendar based on the calendar control file recorded on the recording medium, if the calendar display is switched to album viewing, an album control file selected based on the list of album control files in the calendar control file corresponding to the first predetermined period the representative image of which is displayed on the calendar is read to perform album viewing based on the album control file.

6. A file system for recording image data comprising:
a plurality of image data;
a first file having link information to image data selected from the plurality of image data as having been shot during a predetermined period; and
a second file having link information to image data selected from the plurality of image data as being categorized under a specific theme,
wherein the first file has album link information as link information to the second file having the link information to the image data to which the first file has link information.

7. A recording medium recording the file system according to claim 6.

8. An image reproducing apparatus capable of reading the file system according to claim 6, the apparatus having
a calendar display function for displaying an image shot during the predetermined period based on the first file,
an album viewing function for displaying an image categorized under the specific theme based on the second file,
a function for allowing a user to specify a desired image on the display made by the calendar display function, and
a function for switching, by using the album link information, from the display made by the calendar display function to the display made by the album viewing function based on the second file having the link information to the specified image.

9. An image display method comprising the steps of:
displaying a calendar based on a calendar control file recorded on a recording medium in units of a first predetermined period and containing at least a list of representative image files in units of a second predetermined period shorter than the first predetermined period so that the representative images will be displayed on the calendar in each area corresponding to the second predetermined period; and
performing album viewing based on an album control file recorded on the recording medium and containing at least a list of image files for album viewing,
wherein switching from the calendar display to the album viewing is done based on a list of album control files described in the calendar control file and the album control file.
